(19) United States
(12) Patent Application Publication
(10) Pub. No.: US 2020/0043046 A1
(43) Pub. Date: Feb. 6, 2020

(54) LOCATION PREDICTION

(71) Applicant: Facebook, Inc., Menlo Park, CA (US)

(72) Inventors: Tsuwei Chen, Cupertino, CA (US); Qizhen Ruan, Lexington, MA (US); Roy Koonammave Jose, San Jose, CA (US); Scott J. Bratsman, Pleasant Grove, UT (US); William Bullock, Palo Alto, CA (US); Aude Hofleitner, San Francisco, CA (US); Yoav Shapira, Brookline, MA (US); Mostafa Keikha, Watertown, MA (US)

(21) Appl. No.: 16/054,367

(22) Filed: Aug. 3, 2018

(51) Int. Cl. G06Q 30/02; G06F 17/30; H04W 4/021; G06F 15/18

(52) U.S. Cl. CPC G06Q 30/0261; G06F 17/3087; G06Q 50/01; H04W 4/021; G06F 15/18; G06F 17/30867

(57) ABSTRACT

In one embodiment, a method includes analyzing social graph information associated with users of a social-networking system, developing feature vectors describing elements of social graph information, and applying the feature vectors to determine the relevance of elements of social graph information to the location of special relevance. The method further includes receiving at least one data point from a user's networked device, applying the feature vectors to the at least one data point to determine the relevance of the at least one data point to the location of special relevance, and assigning weight to each data point based on the determined relevance of each data point to the location of special relevance. Finally, the method includes processing the at least one data point according to its assigned weight and forming a prediction, to a particular degree of certainty, indicating the user's location of special relevance.

### TECHNICAL FIELD

This disclosure generally relates to analyzing location information.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments of this disclosure may use information gathered from a user's interaction with a social-networking system, or social graph information, to generate a prediction of a location of special relevance for a user. Particular embodiments of this disclosure may include using a wide selection of social signals and may include using a machine-learning model to predict a user's location of special relevance. The predicted location of special relevance may include a specific location or a more general location. For example and not limitation, a predicted location of special relevance may include a particular city, postal code, or cell tower coverage area. Particular embodiments may include using social graph information that may include, but is certainly not limited to location data associated with, for example: pages that a user “likes,” the locations of special relevance of the user's friends with whom the user has high social graph affinity, business and group pages with which a user interacts, events to which a user indicated attendance or interest, places where the user has indicated arrival or presence, metadata associated with photos the user has uploaded, a user's language preference, recent searches performed by a user and the results selected, and marketplace transactions coordinated via the platform.

In one embodiment, a method may include, by a computing system, training a machine-learning model by analyzing social graph information associated with users of a social-networking system whose location of special relevance is known, developing feature vectors describing elements of social graph information, and applying the feature vectors to determine the relevance of elements of social graph information to the location of special relevance. The method may include receiving at least one data point from a user's networked device, applying the feature vectors to the at least one data point to determine the relevance of the at least one data point to the location of special relevance, assigning weight to each of the at least one data point based on the determined relevance of each of the at least one data point to the location of special relevance, processing the at least one data point according to its assigned weight, and forming a prediction, to a particular degree of certainty, indicating the user's location of special relevance. The method may include retrieving social graph signal data associated with a particular user, generating a feature vector based on the retrieved data, applying the machine-learning model to the feature vectors, and generating a prediction regarding the user's location of special relevance.

Particular embodiments may include applying weights to particular features in the feature vector, based on how often the location appears in the signal data.

Particular embodiments may include, by the computing system, determining whether data points received from a user's networked device over a particular period of time indicate that the user travels often, registering a count for each data point received from the networked device for each unique location associated with the data points to form sets of counts, setting a minimum threshold, determining the sum of the counts for each set of counts associated with each unique location, comparing the sum of each of the sets of counts to the threshold count, and updating the user's location of special relevance if the sum of one set of counts exceeds the threshold count. In this manner, if a user's predicted location of special relevance is not supported by a degree of certainty above the minimum threshold, the user's previously predicted or recorded location of special relevance will remain their recorded location of special relevance.

In one embodiment, the method may include validating a prediction using questions addressed to the user over the social-networking system or website, including, but certainly not limited to questions to confirm whether a user attended a particular event or frequented a particular business. The method may include generating at least one question regarding at least one element of social graph information associated with the user, transmitting the at least one question to the user's networked device, and receiving an answer to the at least one question. The method may include the computing system, based on the user's response, validating at least one element of social graph information associated with the user and updating the prediction indicating the user's location of special relevance.

In particular embodiments, this disclosure may include a system. In one embodiment, the system may include a processor configured to analyze social graph information associated with users of a social-networking system, develop feature vectors describing elements of social graph information, and apply the feature vectors to determine the relevance of elements of social graph information to the location of special relevance. The system may include a receiver, coupled to the processor, configured to receive at least one data point from a user's networked device. The system may include the processor being further configured to apply the feature vectors to the at least one data point to determine the relevance of the at least one data point to the location of special relevance, and to assign weight to each of the at least one data point based on the determined relevance of each of the at least one data point to the location of special relevance. The system may further include the processor being further configured to process the at least one data point according to its assigned weight and to form a prediction, to a particular degree of certainty, indicating the user's location of special relevance.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are disclosed in the attached claims directed to a method, a storage medium, a system and a computer program product, wherein any feature mentioned in one claim category, e.g. method, may be claimed in another claim category, e.g. system, as well. The dependencies or references back in the attached claims are chosen for formal reasons only. However any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### BRIEF DESCRIPTION OF THE DRAWINGS

FIG. 1 illustrates an exemplary embodiment of this disclosure.

FIG. 2 illustrates an exemplary embodiment of this disclosure.

FIG. 3 illustrates an example method for predicting a location of special relevance.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

This disclosure relates to systems and methods for predicting a location of special relevance. In particular, the disclosed systems and methods may be used and configured to predict locations of special relevance for users of a social-networking system or platform, or, for example, a website that receives information from users.

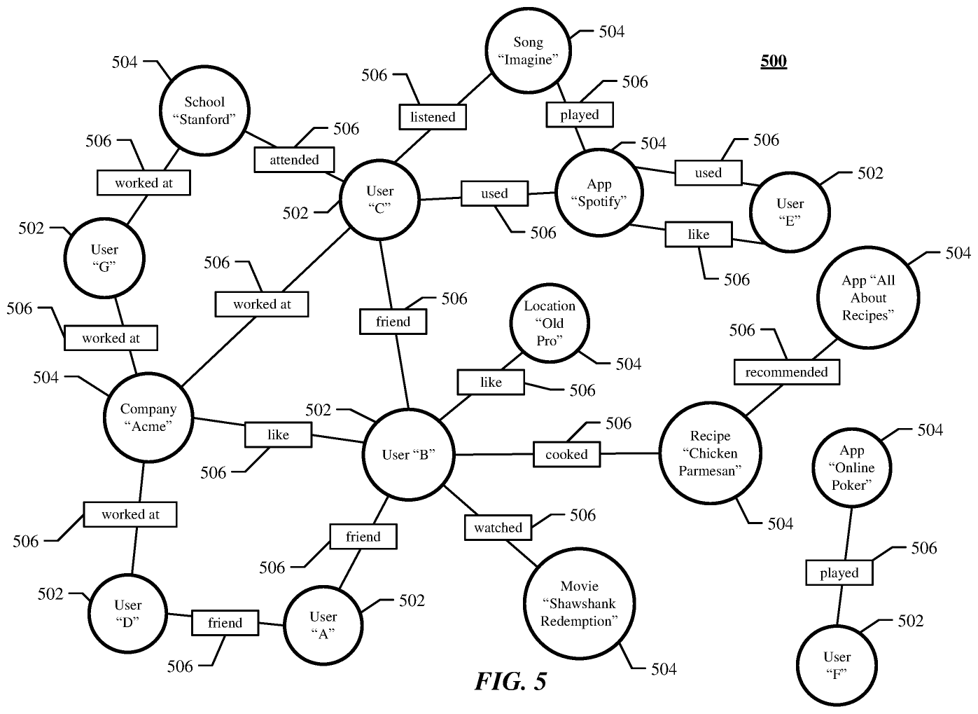

In an exemplary embodiment, a machine-learning algorithm may be trained using social graph information of users whose location of special relevance is known or whose location of special relevance has already been determined to a high degree of certainty. A wide variety of social graph elements, examples of which are shown in FIG. 5, may be used in the disclosed methods and systems to train the machine-learning algorithm to form feature vectors associated with social graph elements, and to determine the tendency of those social graph elements to indicate the location of special relevance. The method may include analyzing the social graph information to develop the feature vectors and may include applying the feature vectors based on the relevance of social graph information to users' locations of special relevance. In particular embodiments, a user's location of special relevance may be a residence, a workplace, a school, a regular recreation location, a store, a place of worship, a transit depot/station/stop, or any other type of location deemed to be of particular significance.

In particular embodiments, examples of features that may be extracted for a user may include: photos or videos uploaded by the user or tagging the user (e.g., with geo tags, or user-tagged with a location), status messages posted by the user or shared with third-party servers (e.g., with geo tags, or including content indicative of a location), check-ins posted by the user or shared with third-party servers (e.g., with geo tags, or including content indicative of a location), search queries entered by the user (e.g., for a specific location, or resulting in a click on a search result regarding a place with a geo tag), viewing or sharing of location-specific content, viewing/liking of location-specific establishments, viewing/liking/sharing of location-specific events (e.g., that the user is interested in, invited to, going to, or hosting/admin for), locations specified in the user's profile (e.g., home location, school location, work location), IP address, location(s) of the user's friends or family members (e.g., with higher weight for cities with higher numbers of friends, or higher weight for cities with friends with whom the user has a higher affinity), or any other location-specific social-graph or third-party-related action. In all embodiments, appropriate privacy settings are made available to the user for configuration by the user, and permissions are required for any use of user-specific information. Additional features that may be extracted include: the user's reported phone number, the population of the location of special relevance, the number of users in the city, or the distance between the location of special relevance being assessed and a known location of special relevance that has been stored in the user's profile.

Following the application of feature vectors to social graph elements, the methods and systems may be employed as to individual users. The method may include receiving data associated with a user of a social-networking system or network from, for example, a networked device associated with the user. The method or system may also include processing data received from the user based on the weight assigned to different social graph elements associated with data of that user. Based on this application, the method or system may predict a particular user's location of special relevance. In particular embodiments, the types of data considered in the determination and/or the values of the assigned weights may vary based on the type of the location of special relevance.

The methods and systems disclosed herein may be used to determine the relevance of particular advertisements to particular users. Based on a predicted location of special relevance to a particular user, the method or system may determine an advertisement of relevance to that particular user and transmit the advertisement to the user's networked device. The advertisement may be delivered to the user over a network and be made available to the user when the user accesses a social-networking system or website, for example via the user's networked device, or the method and system may include sending the advertisement directly to the user via an e-mail or internet message external to the social-networking system or website. The methods and systems disclosed herein may also include determining content and/or services relevant to the user based on the predicted location of special relevance and sending notification to the user's networked device regarding that content or those services. In particular embodiments, the type of advertisement selected for delivery may vary based on the type of the location of special relevance.

The methods and systems disclosed herein may also include determining the number of users of the social-networking system or website located within a particular geographic region by, for example, determining the location of all, most, or some users within a certain geographic area. The methods and systems may estimate, based on the number of users whose locations of special relevance are determined to be within the selected geographic region, the total number of users whose locations of special relevance are within that geographic region. Such a geographic region may be defined, for example, by country, state, county, city, or cell-tower radius geographic areas. In particular embodiments, the determination of the geographic region may vary based on the type of the location of special relevance.

The methods and systems may also include validating a predicted location of special relevance for a user. A predicted location of special relevance may be validated, for example, by generating at least one question regarding one or more elements of social graph information associated with the user. The at least one question may be transmitted to the user's networked device. If and when the user answers a question, the response may be received and processed to validate at least one element of social graph information associated with that user. Such questions may be directed toward elements of social graph information having particularly high relevance to predicting a user's location of special relevance and may be directed toward elements of a user's social graph which were previously determined to be particularly accurate or particularly inaccurate, to increase the certainty with which a user's location of special relevance is predicted.

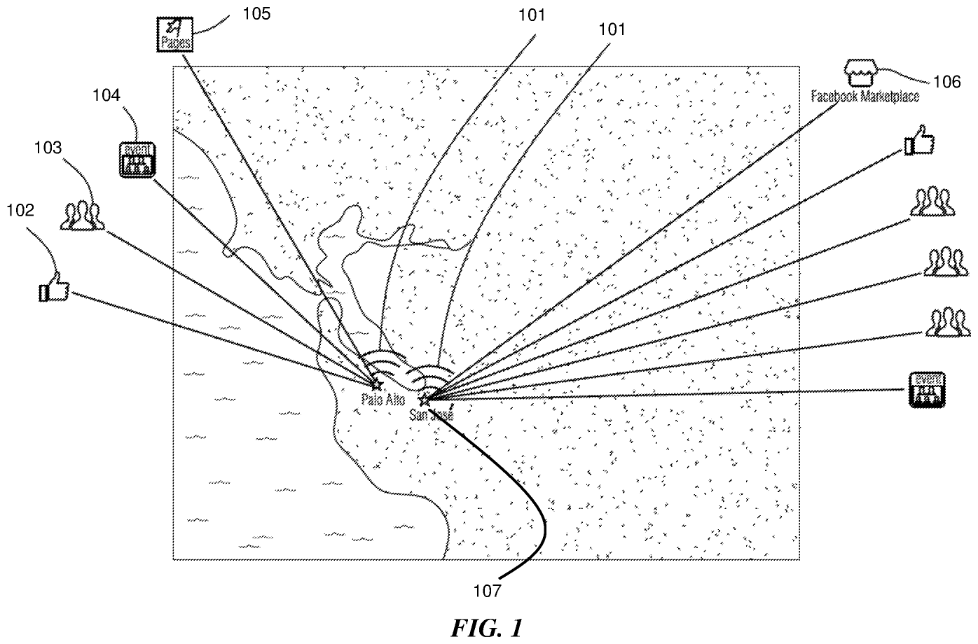

FIG. 1 illustrates an exemplary embodiment of this disclosure. Location data 101 may originate from one or more networked devices associated with users of a social-networking system or platform, or networked devices associated with users of a website that collects, directly or indirectly, data associated with its users or visitors. Location data 101 may include a plethora of social graph information, including, but certainly not limited to social graph elements associated with user “likes” 102 registered on the social-networking system, such as “likes” of posts by other users, or “likes” of pages associated with businesses or events. Location data 101 may also include information related to users' friends 103, including the identities and social media pages of those friends, including friends with whom users have high social graph affinity, as well as other information potentially describing the relationship between users. Location data 101 may also include information about events 104 that a user has attended or for which a user has indicated they will, or will not, attend. Location data 101 may also include page interactions 105 indicating that a user, through a networked device, has interacted with a page that is associated with or hosted on a social-networking system or website, and that is associated with or relates to a public figure or business.

For example, and not limitation, a page interaction 105 might be associated with a business located at a particular area and a user's page interaction 105 might then tend to indicate, in conjunction with other information, that a user's location of special relevance is within a certain distance from that business. In some situations, in accordance with embodiments of this disclosure, a page interaction 105 may be registered for a user related to a business whose location is not near the user's location of special relevance, for example, if a user visits a business on vacation, or if a user interacts on the social-networking system with a business with which that user only interacts via the internet. In accordance with embodiments of this disclosure, methods and systems may be employed to assign proper weight to certain page interactions associated with certain users to determine the likely true location of special relevance of users. Similar methods may be employed with respect to other elements of social graph information associated with users.

Location data 101 may also include marketplace transactions conducted in person and arranged over a social-networking system or internet website. For example and not limitation, such marketplace transactions may tend to carry great weight with respect to predicting a user's location of special relevance because of their suggestion of person-to-person interaction in at least an approximate location. Such data may also be discounted however, based on a variety of factors.

For purposes of illustration and not limitation, in the example of FIG. 1, a user's predicted location of special relevance 107 is in San Jose, and location data is shown to be associated with that user indicating locations at least in the regions of San Jose and Palo Alto. For example, FIG. 1 illustrates a highly simplified version of user location data, which may be associated with a number of locations over a variety of time periods and may also include information not necessarily associated with one specific location. For purposes of illustration, FIG. 1 shows location data associated with a user whose location of special relevance in San Jose is predicted by methods and systems disclosed herein. As disclosed herein, a method implemented on a computer system may apply feature vectors to the variety of data received from the user's networked device, including but not limited to information related to friends 103, “likes” 102, events 104, page interactions 105, and marketplace transactions 106. The data received might also include data associated with a user's location itself, which may be received from a user's networked device using GPS, if made available by a user, using anonymized cellular network information, using the IP address of the user's networked device, or using tags originating from a user's decision to tag data as originating from a certain location or region.

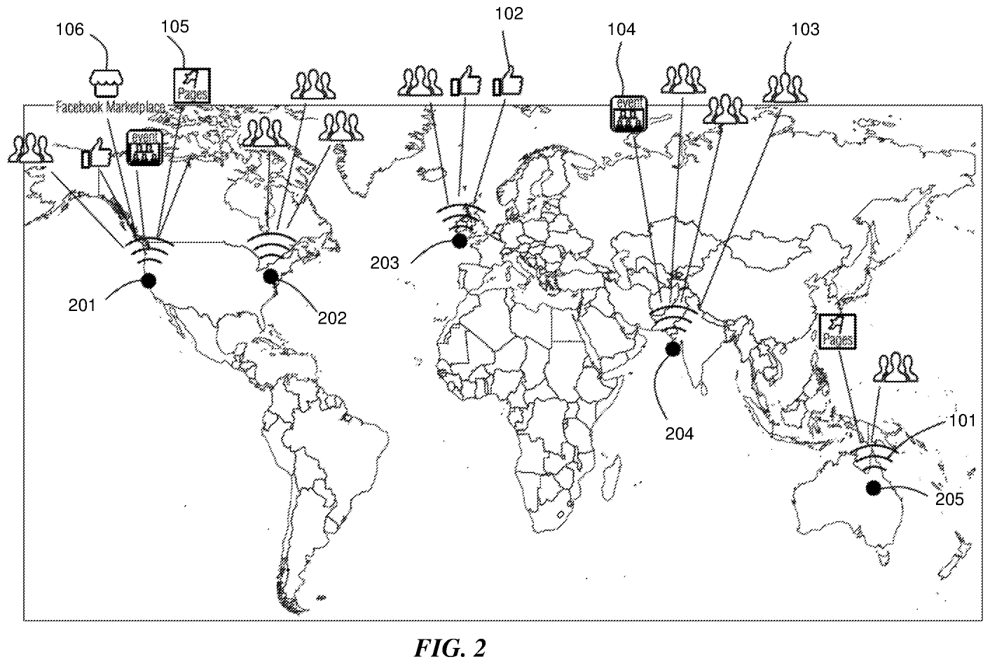

FIG. 2 illustrates an exemplary embodiment of this disclosure in which a disclosed method may account for a user whose location data 101 might tend to indicate that the user travels often. A user who travels often might transmit location data associated with many locations within a short time period. Such location data associated with several locations over a short time period may be received by a receiver employed as part of a computer system employing the disclosed method. For example, and not limitation, a user whose location data is received by a computer system employing the disclosed method might tend to indicate that the user is at some point located at any of user location A 201, user location B 202, user location C 203, user location D 204, or user location E 205. Such location data may also include, for example and not limitation, social graph information, such as user data associated with “likes” 102, data associated with a user's connections or friends 103, data associated with one or more events 104, data associated with user page interactions 105, and data associated with marketplace transactions 106.

In accordance with an exemplary embodiment, the method may include determining whether data 101, including data associated with one or more social graph elements, such as, but not limited to data types 101, 102, 103, 104, 105, and 106, discussed above, tend to indicate that the user travels often. For example and not limitation, the method may determine that a user is a frequent traveler if location data associated with a user's networked device is received that tends to indicate the user's presence in a certain number of new and/or distant locations within a certain period of time. For example and not limitation, location data associated with a user's networked device could be received that tends to indicate that within the span of one month, the user visited at least user Location A 201, user Location B 202, and user Location D 204. For example and not limitation, the disclosed system could have received any of data types 101, 102, 103, 104, 105, and 106, discussed above, from the user at each of these, and other locations.

If the method determines that data received from a user's networked device or devices indicates that the user travels often, the method may register a count for each location data point received from a user's networked device for each location associated with the data points received from the user. The method may group the registered counts together according to unique locations from which the data was received, thereby forming sets of counts. The method may set a minimum threshold for use in determining whether to predict a new location of special relevance for a user. In particular embodiments, the minimum threshold may be an absolute number, a ratio or percentage, or a combination thereof. The method may include determining the sum of the counts for each set of counts associated with a unique location, comparing each of those sums to the minimum threshold, and updating the user's location of special relevance if the sum of one set of counts exceeds the minimum threshold. If no set of counts exceeds the minimum threshold, then the user's previously recorded or previously predicted location of special relevance may remain. For example, if, in the example discussed above, the user's previously recorded location of special relevance was user Location C 203 and none of the location data set counts associated with user Location A 201, user Location B 202, and user Location D 204 exceeded a minimum threshold, then the predicted location of special relevance would remain as user location C 203.

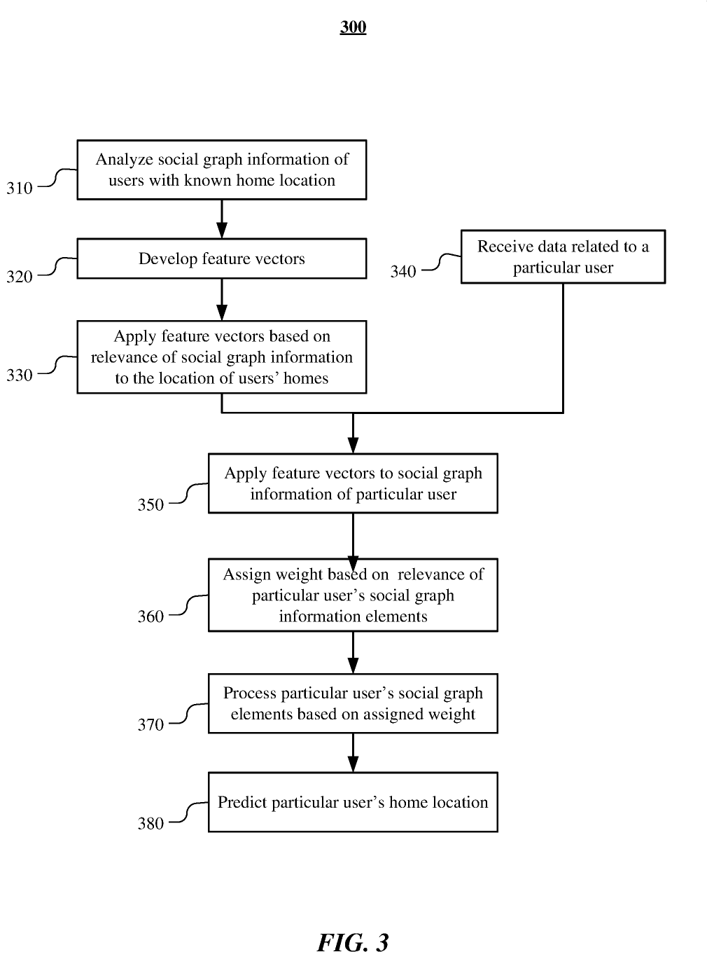

FIG. 3 illustrates an example method 300 for predicting the location of special relevance of a user. The method may begin at step 310, where a computing system may be configured to analyze social graph information of users whose location of special relevance is known, or whose location of special relevance is able to be predicted with a high level of certainty. At step 320, the method may develop feature vectors as part of a training process for a machine learning algorithm. At step 330, the method may apply the feature vectors to social graph information based on the relevance of the information to predicting a user's location of special relevance. At step 340, the computing system may receive data related to a particular user. Data related to particular users may be received from networked devices associated with users. In particular embodiments, steps 310-330 may run independently and in parallel with step 340. At step 350, the method may apply the feature vectors developed by the machine learning algorithm to social graph information contained in the data received from the particular user. At step 360, the method may assign weight to elements of social graph information associated with the particular user, based on the feature vectors applied to those elements. At step 370, the method may process the data related to the particular user based on the assigned weight of each element or data point. At step 380, the method can, based on the processed data received from the particular user, predict the user's location of special relevance. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for predicting the location of special relevance, including the particular steps of the method of FIG. 3, this disclosure contemplates any suitable method for predicting the location of special relevance including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

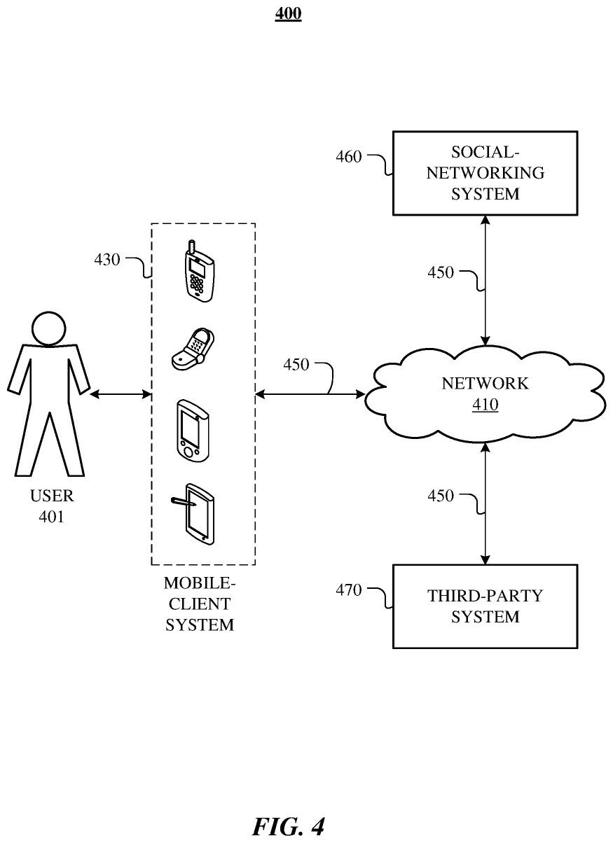

FIG. 4 illustrates an example network environment 400 associated with a social-networking system. Network environment 400 includes a user 401, a client system 430, a social-networking system 460, and a third-party system 470 connected to each other by a network 410. Although FIG. 4 illustrates a particular arrangement of user 401, client system 430, social-networking system 460, third-party system 470, and network 410, this disclosure contemplates any suitable arrangement of user 401, client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of users 401, client systems 430, social-networking systems 460, third-party systems 470, and networks 410, this disclosure contemplates any suitable number of users 401, client systems 430, social-networking systems 460, third-party systems 470, and networks 410. As an example and not by way of limitation, network environment 400 may include multiple users 401, client system 430, social-networking systems 460, third-party systems 470, and networks 410.

In particular embodiments, user 401 may be an individual (human user), an entity (e.g., an enterprise, business, or third-party application), or a group (e.g., of individuals or entities) that interacts or communicates with or over social-networking system 460. In particular embodiments, social-networking system 460 may be a network-addressable computing system hosting an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. In particular embodiments, social-networking system 460 may include an authorization server (or other suitable component(s)) that allows users 401 to opt in to or opt out of having their actions logged by social-networking system 460 or shared with other systems (e.g., third-party systems 470), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 460 through blocking, data hashing, anonymization, or other suitable techniques as appropriate. In particular embodiments, third-party system 470 may be a network-addressable computing system that can host a third-party website. Third-party system 470 may generate, store, receive, and send data associated with a third-party website, such as, for example, advertisements, links, and images. Third-party system 470 may be accessed by the other components of network environment 400 either directly or via network 410. In particular embodiments, one or more users 401 may use one or more client systems 430 to access, send data to, and receive data from social-networking system 460 or third-party system 470. Client system 430 may access social-networking system 460 or third-party system 470 directly, via network 410, or via a third-party system. As an example and not by way of limitation, client system 430 may access third-party system 470 via social-networking system 460. Client system 430 may be any suitable computing device, such as, for example, a personal computer, a laptop computer, a cellular telephone, a smartphone, a tablet computer, or an augmented/virtual reality device.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party system 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506. The degree of separation between two objects represented by two nodes, respectively, is a count of edges in a shortest path connecting the two nodes in the social graph 500. As an example and not by way of limitation, in the social graph 500, the user node 502 of user “C” is connected to the user node 502 of user “A” via multiple paths including, for example, a first path directly passing through the user node 502 of user “B,” a second path passing through the concept node 504 of company “Acme” and the user node 502 of user “D,” and a third path passing through the user nodes 502 and concept nodes 504 representing school “Stanford,” user “G,” company “Acme,” and user “D.” User “C” and user “A” have a degree of separation of two because the shortest path connecting their corresponding nodes (i.e., the first path) includes two edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to an edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 460). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 460 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 460) or RSVP (e.g., through social-networking system 460) to an event associated with the advertisement. In addition or as an alternative, an advertisement may include social-networking-system content directed to the user. As an example and not by way of limitation, an advertisement may display information about a friend of the user within social-networking system 460 who has taken an action associated with the subject matter of the advertisement.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more objects (e.g., content or other types of objects) of a computing system may be associated with one or more privacy settings. The one or more objects may be stored on or otherwise associated with any suitable computing system or application, such as, for example, a social-networking system 460, a client system 430, a third-party system 470, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node 504 corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 460 or shared with other systems (e.g., a third-party system 470). Although this disclosure describes using particular privacy settings in a particular manner, this disclosure contemplates using any suitable privacy settings in any suitable manner.

In particular embodiments, privacy settings may be based on one or more nodes or edges of a social graph 500. A privacy setting may be specified for one or more edges 506 or edge-types of the social graph 500, or with respect to one or more nodes 502, 504 or node-types of the social graph 500. The privacy settings applied to a particular edge 506 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 460. The object may be associated with a concept node 504 connected to a user node 502 of the first user by an edge 506. The first user may specify privacy settings that apply to a particular edge 506 connecting to the concept node 504 of the object, or may specify privacy settings that apply to all edges 506 connecting to the concept node 504. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 460 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 460 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 470, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 462 may be authorization/privacy servers for enforcing privacy settings. In response to a request from a user (or other entity) for a particular object stored in a data store 464, the social-networking system 460 may send a request to the data store 464 for the object. The request may identify the user associated with the request and the object may be sent only to the user (or a client system 430 of the user) if the authorization server determines that the user is authorized to access the object based on the privacy settings associated with the object. If the requesting user is not authorized to access the object, the authorization server may prevent the requested object from being retrieved from the data store 464 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 460, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 460 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 460 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 460 may access such information in order to provide a particular function or service to the first user, without the social-networking system 460 having access to that information for any other purposes. Before accessing, storing, or using such objects or information, the social-networking system 460 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 460.

In particular embodiments, a user may specify whether particular types of objects or information associated with the first user may be accessed, stored, or used by the social-networking system 460. As an example and not by way of limitation, the first user may specify that images sent by the first user through the social-networking system 460 may not be stored by the social-networking system 460. As another example and not by way of limitation, a first user may specify that messages sent from the first user to a particular second user may not be stored by the social-networking system 460. As yet another example and not by way of limitation, a first user may specify that all objects sent via a particular application may be saved by the social-networking system 460.

In particular embodiments, privacy settings may allow a first user to specify whether particular objects or information associated with the first user may be accessed from particular client systems 430 or third-party systems 470. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 460 may provide default privacy settings with respect to each device, system, or application, and/or the first user may be prompted to specify a particular privacy setting for each context. As an example and not by way of limitation, the first user may utilize a location-services feature of the social-networking system 460 to provide recommendations for restaurants or other places in proximity to the user. The first user's default privacy settings may specify that the social-networking system 460 may use location information provided from a client device 430 of the first user to provide the location-based services, but that the social-networking system 460 may not store the location information of the first user or provide it to any third-party system 470. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

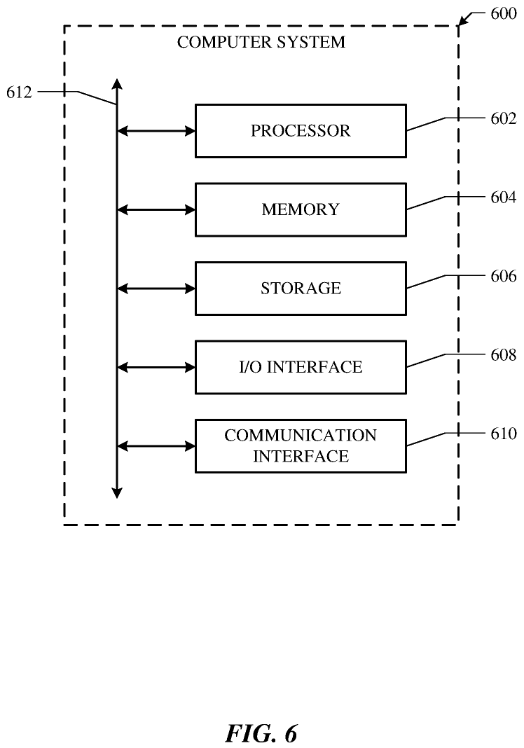

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing system, analyzing social graph information associated with users of a social-networking system;
by the computing system, developing feature vectors representing elements of social graph information;
by the computing system, applying the feature vectors to determine the relevance of elements of social graph information to the location of special relevance;
by the computing system, receiving data items from a networked device associated with a user of the social-networking system;
by the computing system, applying the feature vectors to the at least one data point to determine the relevance of the at least one data point to the location of special relevance;
by the computing system, assigning weight to each of the at least one data point based on the determined relevance of each of the at least one data point to the location of special relevance;
by the computing system, processing the at least one data point according to its assigned weight; and
by the computing system, forming a prediction, to a particular degree of certainty, indicating a location of special relevance to the user.

2. The method of claim 1, further comprising the steps of:
by the computing system, determining an advertisement relevant to the user based on the predicted location of special relevance; and
by the computing system, transmitting the advertisement to the user's networked device.

3. The method of claim 1, further comprising the steps of
by the computing system, determining services relevant to the user based on the predicted location of special relevance; and
by the computing system, transmitting notification of the services to the user's networked device.

4. The method of claim 1, further comprising the steps of:
by the computing system, forming a prediction, to a particular degree of certainty, indicating the location of special relevance of users within a particular geographic region; and
by the computing system, determining a number of total users whose location of special relevance is within the particular geographic region.

5. The method of claim 1, wherein the at least one data point from a user's networked device includes social graph information associated with a user account.

6. The method of claim 5, wherein the social graph information associated with the user account includes at least one connection to a second user.

7. The method of claim 5, wherein the social graph information associated with the user account includes at least one-page interaction.

8. The method of claim 5, wherein the social graph information associated with the user account includes at least one marketplace transaction.

9. The method of claim 1, further comprising the steps of:
by the computing system, generating at least one question regarding at least one element of social graph information associated with the user;
by the computing system, transmitting the at least one question to the user's networked device;
by the computing system, receiving an answer to the at least one question;
by the computing system, based on the user's response, validating at least one element of social graph information associated with the user; and
by the computing system, updating the prediction indicating the user's location of special relevance.

10. The method of claim 1, further comprising the steps of:
by the computing system, determining whether data points received from a user's networked device over a particular period of time indicate that the user travels often;
by the computing system, registering a count for each data point received from the networked device for each unique location associated with the data points to form sets of counts;
by the computing system, setting a minimum threshold;
by the computing system, determining the sum of the counts for each set of counts associated with each unique location;
by the computing system, comparing the sum of each of the sets of counts to the minimum threshold; and
by the computing system, updating the user's location of special relevance if the sum of one set of counts exceeds the minimum threshold.

11. A system comprising:
a processor configured to:
analyze social graph information associated with users of a social-networking system;
develop feature vectors describing elements of social graph information;
apply the feature vectors to determine the relevance of elements of social graph information to the location of special relevance;
a receiver, coupled to the processor, configured to receive at least one data point from a user's networked device;
the processor being further configured to:
apply the feature vectors to the at least one data point to determine the relevance of the at least one data point to the location of special relevance;
assign weight to each of the at least one data point based on the determined relevance of each of the at least one data point to the location of special relevance;
process the at least one data point according to its assigned weight; and
form a prediction, to a particular degree of certainty, indicating the user's location of special relevance.

12. The system of claim 11, wherein the processor is further configured to:
determine an advertisement relevant to the user based on the predicted location of special relevance; and
transmit the advertisement to the user's networked device.

13. The system of claim 11, wherein the processor is further configured to:
determine services relevant to the user based on the predicted location of special relevance; and
transmit notification of the services to the user's networked device.

14. The system of claim 11, wherein the processor is further configured to:
form a prediction, to a particular degree of certainty, indicating the location of special relevance of users within a particular geographic region; and
determine a number of total users whose location of special relevance is within the particular geographic region.

15. The system of claim 11, wherein the at least one data point from a user's networked device includes social graph information associated with a user account.

16. The system of claim 11, wherein the social graph information associated with the user account includes at least one-page interaction.

17. The system of claim 11, wherein the social graph information associated with the user account includes at least one marketplace transaction.

18. The system of claim 11, further comprising:
the processor being further configured to:
generate at least one question regarding at least one element of social graph information associated with the user;
transmit the at least one question to the user's networked device;
the receiver being further configured to receive an answer to the at least one question;
the processor being further configured to:
validate at least one element of social graph information associated with the user; and
update the prediction indicating the user's location of special relevance.

19. The system of claim 11, wherein the processor is further configured to:
determine whether data points received from a user's networked device over a particular period of time indicate that the user travels often;
register a count for each data point received from the networked device for each unique location associated with the data points to form sets of counts;
set a minimum threshold;
determine the sum of the counts for each set of counts associated with each unique location;
compare the sum of each of the sets of counts to the minimum threshold; and
update the user's location of special relevance if the sum of one set of counts exceeds the minimum threshold.

20. One or more computer-readable non-transitory storage media embodying software that is operable when executed to:
analyze social graph information associated with users of a social-networking system;
develop feature vectors describing elements of social graph information;
apply the feature vectors to determine the relevance of elements of social graph information to the location of special relevance;
receive at least one data point from a user's networked device;
apply the feature vectors to the at least one data point to determine the relevance of the at least one data point to the location of special relevance;
assign weight to each of the at least one data point based on the determined relevance of each of the at least one data point to the location of special relevance;
process the at least one data point according to its assigned weight; and
form a prediction, to a particular degree of certainty, indicating the user's location of special relevance.
